(19) United States
(12) Patent Application Publication
(10) Pub. No.: US 2004/0036833 A1
(43) Pub. Date: Feb. 26, 2004

(54) Flexible substrate, LCD module using same, and manufacturing method of same

(75) Inventor: Masahiko Monzen, Fukuyama-shi (JP)

Correspondence Address: NIXON & VANDERHYE, PC, 1100 N GLEBE ROAD, 8TH FLOOR, ARLINGTON, VA, 22201-4714, US

(73) Assignee: SHARP KABUSHIKI KAISHA, Osaka (JP)

(21) Appl. No.: 10/643,992

(22) Filed: Aug. 20, 2003

(30) Foreign Application Priority Data
Aug. 23, 2002 (JP) 2002-244003

(51) Int. Cl. G02F 1/1345; G02F 1/1333

(52) U.S. Cl. 349/158

(57) ABSTRACT

A flexible substrate of the present invention is provided with a plurality of terminal blocks, each of which has a plurality of electrode terminals, there being two kinds of terminal pitches with which the plurality of electrode terminals are arrayed respectively in the plurality of terminal blocks, a compensation amount being set for each terminal block in accordance with the terminal pitch thereof. With this arrangement, it is possible to connect the electrode terminals of the flexible substrate with electrode terminals of an LCD without misalignment. That is, it is possible to match positions of the terminals of the flexible substrate with positions of the terminals of the LCD, so as to inhibit imperfect connection due to the misalignment caused after the thermal compression bonding.

### FIELD OF THE INVENTION

The present invention relates to (a) a flexible substrate including a plurality of terminal blocks, each of which is provided with a plurality of electrode terminals, the plurality of terminal blocks arranged with at least two kinds of terminal pitches, (b) an LCD module using the same, and (c) a manufacturing method of the same.

### BACKGROUND OF THE INVENTION

Today, LCDs (Liquid Crystal Display apparatus) has become a display apparatus typically chosen for displaying information. For example, the use of LCDs is inevitable in portable information apparatuses, such as portable telephones, PHS (Personal Handy-phone System) apparatus, and the like. Parts to be used in those apparatuses should have a light weight and a compact size. To an LCD substrate to be integrated in those apparatus, a flexible substrate (COF (Chip On Flexible printed circuit board), TCP (Tape Carrier Package), TAB (Tape Automated Bonding), FPC (Flexible Printed Circuit), and the like) is connected via an anisotropic conductive material by thermal compression bonding. The flexible substrate has (a) equally-pitched terminals (terminals arrayed with constant pitch) on one edge, and (b) a liquid crystal driver connected to the terminals. With this arrangement, the LCD substrate is driven by the liquid crystal driver.

In this case, the LCD substrate made of glass and the flexible substrate are different in terms of coefficient of thermal expansion. Thus, the LCD substrate or the flexible substrate should have a design in which elongation compensation is taken into consideration. In general, arts in which such compensation is carried out for the flexible substrate is adopted.

For example, Japanese Publication of Unexamined Patent Application “Tokukaihei No. 4-289824” (published on Oct. 14, 1992) is one of such arts. In this publication, positional misalignment between electrode terminals of an LCD substrate and lead terminals of a flexible substrate is avoided by having terminal pitches that are set in consideration of elongation of a base film of the flexible substrate, the elongation caused during a thermal compression bonding step.

Moreover, for example, Japanese Publication of Unexamined Patent Application “Tokukai No. 2000-312070” (published on Nov. 7, 2000) is another one of such arts. In this publication, either outgoing electrode terminals of an LCD substrate or output electrode terminals of a flexible substrate have constant pitch, whereas the others are so arranged as to have terminal pitches compensated in accordance with coefficient of thermal expansion of the flexible substrate, so that they are arrayed with small terminal pitches in middle portion of a terminal section, and the terminals nearer to edges of the substrate have wider terminal pitches. In this way, imperfect connection is reduced.

The related arts of the publications are applicable to an TFT (Thin Film Transistor)-LCD, where the terminal pitches are constant. However, in case of an STN (Super-Twisted Nematic)-LCD that is subjected to COMMON transfer, it is necessary that the COMMON transfer be performed so as to provide SEGMENT terminals and COMMON terminals on a glass side of one of substrates, and terminal widths of those terminals be varied. It is a problem that the related arts are not applicable in this case.

Referring to FIGS. 5(a) to 5(c), and 6(a) to 6(c), the normal transfer is explained below. FIGS. 5(a) to 5(c) are views explaining an LCD module that is not subjected to the normal transfer. An upper glass substrate shown in FIG. 5(a) and a lower glass substrate shown in FIG. 5(b) are bonded together together, and then liquid crystal is sealed therebetween. A COF, which is provided with a driver IC (integrated circuit) for driving COMMON electrodes, is connected on the upper glass substrate by the thermal compression bonding. Whereas, a COF which is provided with a driver IC for driving SEGMENT electrodes, is connected on the lower glass substrate by the thermal compression bonding. Hereby, an LCD module shown in FIG. 5(c) is prepared.

On the other hand, FIGS. 6(a) to 6(c) are views explaining an LCD module that is subjected to the COMMON transfer. As shown in FIG. 6(a), an upper glass substrate and a lower glass substrate, which are shown in FIG. 6(b), are connected together, the upper glass substrate provided with COMMON electrodes which outgo in the same direction as SEGMENT electrodes of the lower substrate. Then, liquid crystal is sealed therebetween. Hereby, parts A and B of the upper substrate and corresponding parts A and B of the lower substrate are electrically connected, so that COMMON electrodes are formed on the lower glass substrate. Thereafter, a COF including a driver IC for driving the COMMON electrodes is connected onto the upper glass substrate by the thermal compression bonding, whereas a COF including a driver IC for driving the SEGMENT electrodes is connected onto the lower substrate by the thermal compression bonding. In this case, an LCD module as shown in FIG. 6(c) is prepared.

In case of such an LCD that is subjected to the COMMON transfer, it is necessary that the SEGMENT terminals and the COMMON electrodes (terminals) be provided on a glass side of one of substrates, and widths of the terminals be varied, as described above. Especially, if terminal pitches are less than 100 μm (narrow pitches), the flexible substrate elongates at different elongation rates in parts having different pitches. Because of this, it is difficult to connect the flexible substrate to the LCD without causing misalignment.

### SUMMARY OF THE INVENTION

In view of the aforementioned problems, the present invention has an object to provide (a) a flexible substrate whose electrode terminals, which have different pitches, can be connected with their counterpart electrode terminals without causing imperfect connection after thermal compression bonding, (b) an LCD module using the same, and (c) a manufacturing method of the same.

In order to attain the aforementioned object, a flexible substrate of the present invention is provided with a plurality of terminal blocks, each of which has a plurality of electrode terminals, there being two kinds of terminal pitches with which the plurality of electrode terminals are arrayed respectively in the plurality of terminal blocks, a post-thermal-compression-bonding elongation compensation amount (an amount of compression for elongation that is caused after thermal compression bonding) being set for each terminal block in accordance with the terminal pitch thereof.

With this arrangement, the flexible substrate such as a TCP, a COF, an FPC and the like is connected with its counterparts (such as an LCD) with which the flexible substrate is to be connected. In connecting, the plurality of terminal blocks provided to the flexible substrate are connected with the corresponding terminal blocks of the counterparts, by the thermal compression bonding.

Incidentally, in case of the flexible substrate in which at least one terminal block has a different terminal pitches of electrode terminals from that of the other terminal blocks, if the terminal pitches are small (less than 100 μm), the conventional elongation compensation cannot attain such good alignment between the flexible substrate and its counterpart (such as an LCD) that all of the terminal blocks are well connected with their counterpart terminal blocks respectively.

With this arrangement, it is possible to connect the electrode terminals of the flexible substrate with the electrode terminals of its counterpart (such as an LCD) with respect to all of the terminal block (that is, all of the terminal blocks are well connected with their counterpart terminal blocks respectively), because the compensation amounts are set in accordance with the terminal pitches.

Moreover, an LCD module of the present invention is so arranged as to include any one of the flexible substrate described above, in order to attain the aforementioned object.

With this arrangement, in an LCD module prepared by bonding a flexible substrate (such as a TCP, a COF, and PC) onto a substrate (such as glass) by using an anisotropic conductive material or the like, it is possible to attain good connection of the electrode terminals for all the terminal blocks without misalignment, by using the one of the flexible substrates described above. Specifically, when this arrangement is adopted in such an LCD and the one of the flexible substrates described above is used, for all the terminal blocks, the electrode terminals of the flexible substrate, and the electrode terminals of the counterpart with which the flexible substrate (such as an LCD) is connected, are connected without misalignment. In addition, it is possible to inhibit imperfect connection due to misalignment caused by the thermal compression bonding.

Furthermore, in order to attain the aforementioned object, a method of the present invention of manufacturing a liquid crystal display module in which a liquid crystal substrate is connected with a flexible substrate including a plurality of terminal blocks, each of the plurality of terminal blocks having a plurality of electrode terminals, and the plurality of terminal blocks including a first terminal block and a second terminal blocks having different terminal pitches, the method including the steps of: (i) performing compression bonding of a test flexible substrate made of the same material as the flexible substrate and including a plurality of terminal blocks having a predetermined terminal pitch; (ii) measuring an amount of a size change in the terminal pitch in each terminal block, the size change caused by the compression bonding; (iii) determining a compensation amount of the terminal pitch of each terminal block, based on the amount of the size change thereof; (iv) setting terminal pitches of the flexible substrate by compensating the terminal pitches of the test flexible substrate by the compensation amount; (v) manufacturing the flexible substrate so that the flexible substrate has the thus set terminal pitches; and (vi) performing thermal compressing bonding of the flexible substrate so as to connect the flexible substrate with the liquid crystal display apparatus, wherein, in the step of determining, the compensation amount is determined for each terminal block having in accordance with the terminal pitch thereof.

According to this method, in an LCD module prepared by bonding a flexible substrate (such as a TCP, a COF, and an FPC) onto a substrate (such as glass) by using an anisotropic conductive material or the like, it is possible to attain good connection of the electrode terminals for all the terminal blocks without misalignment. Specifically, when this arrangement is adopted in such an LCD, for all the terminal blocks, the electrode terminals of the flexible substrate, and the electrode terminals of the counterpart with which the flexible substrate (such as an LCD) is connected, are connected without misalignment. In addition, it is possible to inhibit imperfect connection due to misalignment caused by the thermal compression bonding.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a plan view illustrating connecting portions of the flexible substrate and of an LCD substrate of one embodiment of the present invention. With the connecting portions, the flexible substrate and the LCD substrate are to be connected.

FIG. 2 is a side view illustrating how the flexible substrate and the LCD substrate are connected by the thermal compression bonding.

FIG. 3 is a perspective view of an LCD module prepared in the thermal compression bonding mentioned above.

FIG. 4 is a plan view illustrating connecting portions of the flexible substrate and of an LCD substrate of another embodiment of the present invention. With the connecting portions, the flexible substrate and the LCD substrate are to be connected.

FIGS. 5(a) to 5(c) are views explaining an LCD module that is not subjected to COMMON transfer.

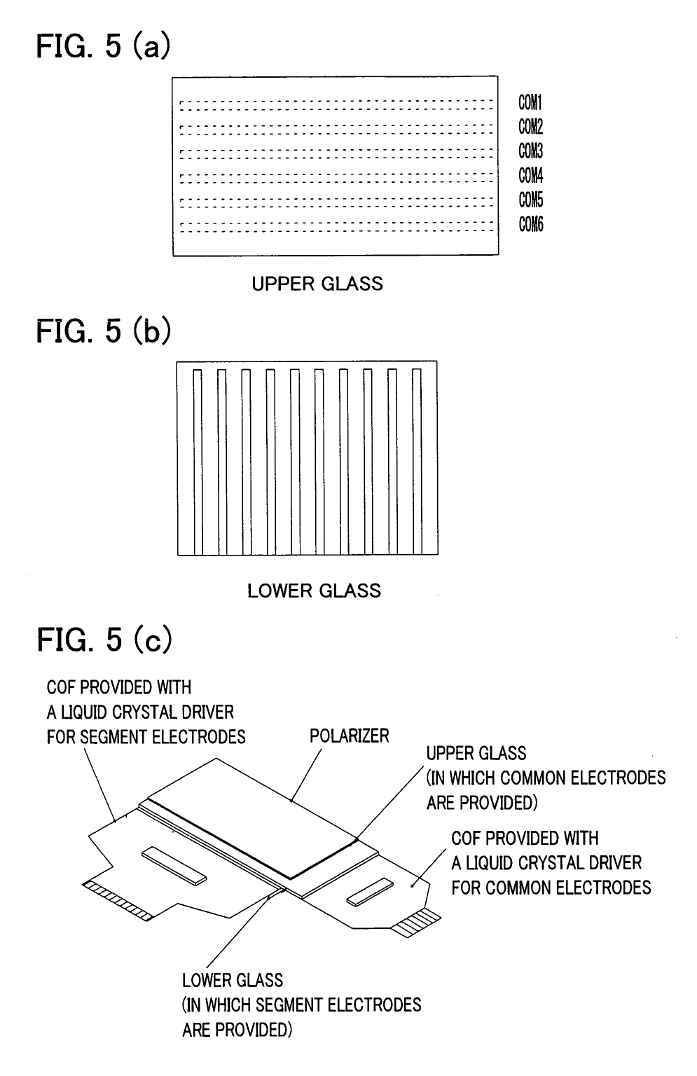

FIGS. 6(a) to 6(c) are views explaining an LCD module that is subjected to the COMMON transfer.

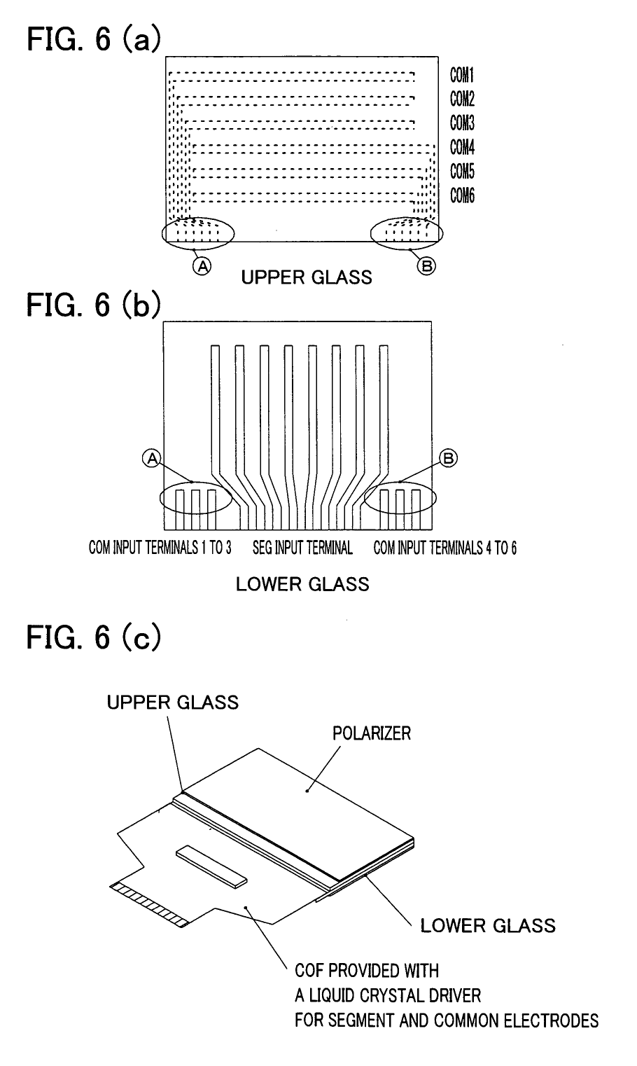

### DESCRIPTION OF THE EMBODIMENTS

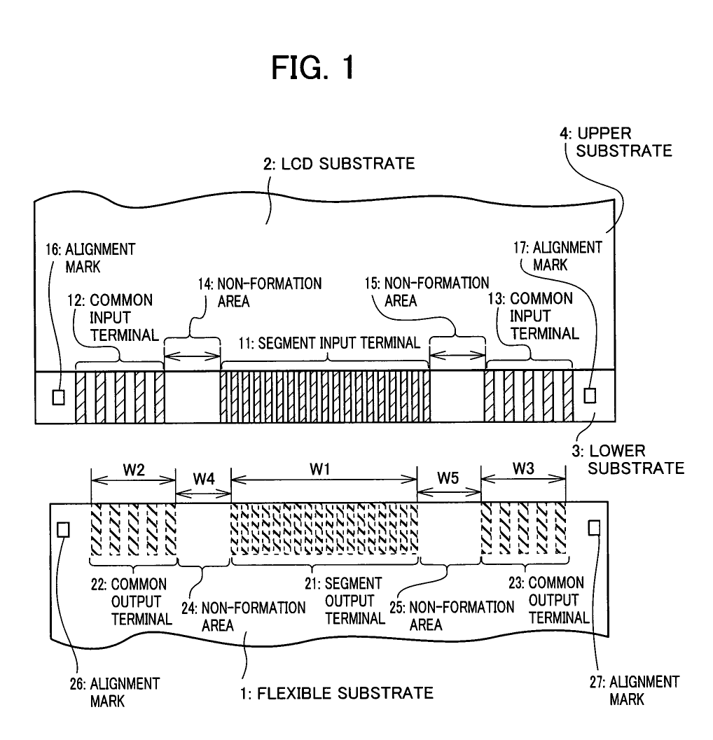

Described below is one embodiment of the present invention, with reference to FIGS. 1 to 3.

FIG. 1 is a plan view illustrating connecting portions of the flexible substrate 1 and of an LCD substrate 2 of one embodiment of the present invention. With the connecting portions, the flexible substrate 1 and the LCD substrate 2 are to be connected. FIG. 1 explains how terminal pitches are compensated according to the present invention. This compensation may be carried out for one of a flexible substrate 1 and an LCD substrate 2. However, the compensation is carried out for the flexible substrate 1 in the following explanation.

The LCD substrate 2 is structured as follows: an upper substrate 4 is connected on a lower substrate 3, the upper substrate 4 and the lower substrate 3 being bonded; STN liquid crystal is hermetically sealed between the substrates 3 and 4; a plurality of SEGMENT input terminals 11 (electrode terminals) are provided in a middle portion of an edge of the lower substrate 3, the middle portion being not covered by the upper substrate 4. The plurality of SEGMENT input terminals 11 form a terminal block (first terminal block); near both side portions of the flexible substrate 1, COMMON input terminals 12 and 13 (electrode terminals) are respectively provided by COMMON transfer as described above. The COMMON input terminals 12 and 13 constitute terminal blocks (second terminal blocks), respectively. The SEGMENT input terminals 11 have comparatively fine (very narrow) terminal pitches, whereas the COMMON input terminals 12 and 13 have comparatively broad terminal pitches. In other word, the terminal pitch of the first terminal block is narrower than the terminal pitch of the second terminal blocks. On both sides of each SEGMENT input terminal 11, that is, (a) between the respective SEGMENT input terminals 11 and the respective COMMON input terminals 12, and (b) between the respective SEGMENT input terminals 11 and the respective COMMON input terminals 13, non-formation areas 14 and 15 in which no electrode terminal is provided, are formed. Moreover, near both side portions of the lower substrate 3, alignment marks 16 and 17 are respectively provided. The alignment marks 16 and 17 are for positional alignment of the flexible substrate 1 in bonding the flexible substrate 1 with the LCD substrate 2.

Meanwhile, the flexible substrate 1 is composed of a COF, a TCP, a TAB, an FPC, or the like. On an edge of a black surface of the flexible substrate 1, SEGMENT output terminals 21 are provided in a middle portion of the edge of the back surface, the SEGMENT output terminals 21 respectively corresponding to the SEGMENT input terminals 11. Near the side portions of the flexible substrate, COMMON output terminals 22 and 23 are respectively provided, the COMMON output terminals 22 and 23 respectively corresponding to the common input terminals 12 and 23. On both sides of the SEGMENT output terminals 21, non-formation areas 24 and 25, in which no electrode terminal is provided, are formed. Moreover, on both side portions of the flexible substrate 1, alignment marks 26 and 27 are provided respectively. In this way, the flexible substrate 1 corresponds to the lower substrate 3.

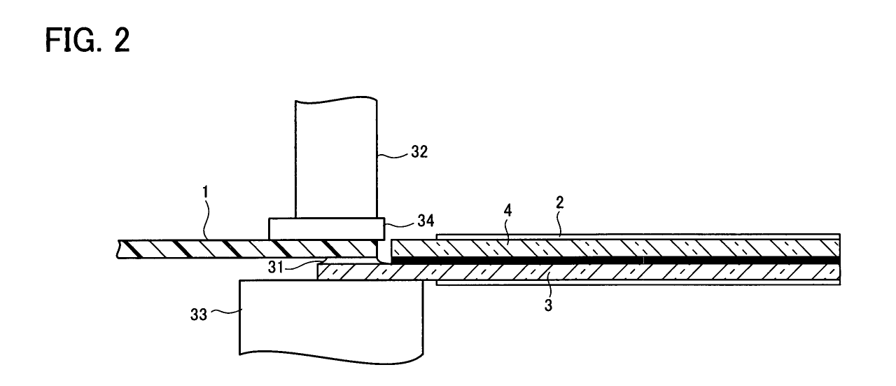

The flexible substrate 1 and the LCD substrates 2 having the above arrangement are, as shown in FIG. 2, connected together so that the alignment marks 16 and 17 respectively match with the alignment marks 26 and 27, and then subjected to temporary compression bonding so as to be temporally connected together. After that, the thus temporally connected flexible substrate 1 and the LCD substrate are subjected to compression bonding by using a tool 32 that is set at a temperature in a range of 200° C. to 250° C. In this way, the output terminals 21, 22, and 23 of the flexible substrate 1 are electrically connected with the input terminals 11, 12, and 13 of the LCD substrate 2, respectively. Here, a back surface of the LCD substrate 2 is supported by a backup 33. A bonding cushioning material 34 is provided at a tip of the tool 32. Hereby, an LCD module 41 is prepared.

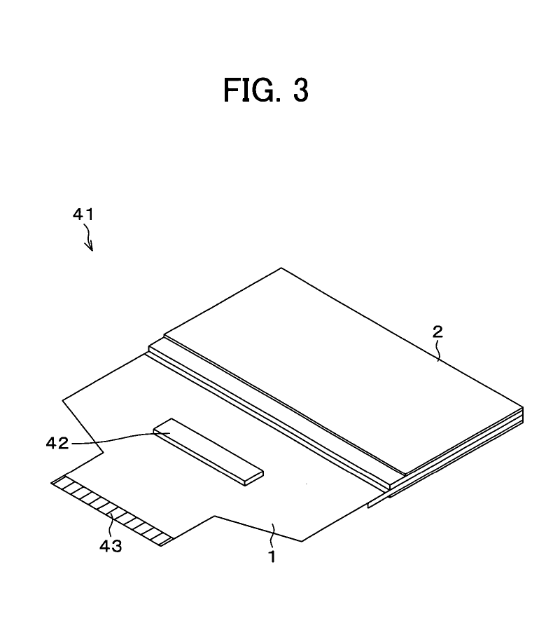

The thus prepared LCD module 41 is as shown in FIG. 3, in case of the LCD module 41 is used for a small screen for a portable telephone and the like. Here, one flexible substrate 1 is used for the LCD substrate 2. The flexible substrate 1 is provided with a driver IC 42 and an electrode terminal 43. The electrode terminal 43 is located on an edge opposite to the edge on which the output terminals 21 to 23 are located. A video signal and power are supplied to the electrode terminal 43.

If the terminal pitches of the terminals 11, 12, 13, 21, 22, and 23 (see FIG. 1) are less than 100 μm, that is, they are narrow pitches (fine pitches), elongation rates (coefficient of thermal expansion) of the flexible substrate are different in parts having different terminal pitches. Therefore, in this case, it is difficult to connect the flexible substrate 1 to the LCD substrate 2 by the thermal compression bonding without misalignment. Thus, in the present invention, the terminal pitches of the flexible substrate are compensated as follows, in order to prevent imperfect connection (failure in boding) due to the misalignment.

Even for parts having the same output pitches, different materials of the flexible substrate 1 have different coefficients of thermal expansion. Thus, a test is carried out by using a substrate (test flexible substrate) made of the same material as the flexible substrate 1 that is used for an actual product. The test flexible substrate is made of the same material as the flexible substrate 1 and provided with a plurality of terminal blocks as the flexible substrate 1 does, the terminal blocks being formed with a predetermined terminal pitch). The test flexible substrate is subjected to compression bonding (thermal compression bonding). As to (a) the plurality of terminal blocks of the output terminals 21, 22, and 23, and (b) the non-formation areas 24 and 25, amounts of change (change amount) in widths W1 to W5 are measured, the change caused by the compression bonding. Compensation rate in each area is determined from differences (change amounts in widths) between the widths measured before the compression bonding and those measured after the compression bonding. Note that in the measurement, for each of the terminals blocks of the output terminals 21, 22, and 23, a distance between both outmost terminals (a change amount in the distance) are measured for the sake of high measurement accuracy.

Based on the thus determined compensation rates (coefficient of thermal expansion) and a number of the terminals (=a distance from a midpoint of an edge of the substrate), the flexible substrate 1 in which the terminals 21, 22, and 23 are formed is produced, the terminals 21, 22, and 23 having terminal pitches compensated orderly (that are compensated by their own compensation amounts. The compensation amounts of the output terminals 21, 22, and 23 are greater in this order. In other words, the terminal pitches of the test flexible substrate are compensated based the compensation rates, so as to find out setting of the terminal pitches of the flexible substrate that is to be used in an actual product. Then, the flexible substrate is manufactured with the terminal pitches thus set. In finding out the setting of the terminal pitches, suitable compensation amounts are determined for the respective terminals. For example, in case one flexible substrate 1 having a thickness of 40 μm is used, a terminal block to have a 80 μm pitch is compensated by having a pre-compression terminal pitch of 99.85% of 80 μm (so that the terminal block has a terminal pitch of 80 μm after the thermal compression bonding). For terminal block to have a 70 μm pitch in the flexible substrate 1 having a thickness of 40 μm, the terminal block is compensated by having a pre-compression terminal pitch of 99.89% of 70 μm (so that the terminal block has a terminal pitch of 70 μm after the thermal compression bonding).

By arranged as such, even if the terminals 11, 12, 13, 21, 22, and 23 having different terminal pitches are used, and the flexible substrate 1 is expanded, (a) positions of the output terminals 21, 22, and 23 on the flexible substrate 1 and (b) positions of the corresponding input terminals 11, 12, and 13 on the LCD substrate 2, are connected respectively without causing misalignment after the thermal compression bonding. Thereafter, the flexible substrate thus manufactured is connected to the LCD substrate by the thermal compression bonding.

Moreover, as described above, the present invention is so arranged that the SEGMENT terminals 11 and 21 having the fine pitch are provided in the middle portion, and the COMMON terminals 12, 13, 22, and 23 having comparatively broader terminal pitches are respectively provided near the side portions of the flexible substrate 1. For the SEGMENT terminals 11 and 21, a half of the terminal pitch, that is, 50% of the SEGMENT terminals 11 and 21 is an actual terminal portion, whereas the other 50% is a space portion, as normally designed. On the other hand, the COMMON terminals 12, 13, 22, and 23 have a narrower actual terminal portion. For example, 45% of the terminal pitch of the COMMON terminals 12, 13, 22, and 23, is an actual terminal portion whereas the rest 55% is a space portion. That is, a ratio between a terminal width and the terminal pitch (a terminal width/terminal pitch ratio) of the SEGMENT terminals 11 and 12 in the middle portion is greater than that ratio of the COMMON terminals 12, 13, 22 and 23 respectively located in the side portions.

Therefore, as to the SEGMENT terminals 11 and 12 having the fine terminal pitch, this arrangement makes it possible to alleviate misalignment in the vicinity of the middle portion of the flexible substrate 1, the misalignment caused by the thermal compression bonding. As to the COMMON terminals 12, 13, 22, and 23, having the comparatively broad width, even if misalignment is caused by the thermal compression bonding, there is a high possibility that the positions of the common output terminals 22 and 23 of the flexible substrate 1 locate within the width of the common input terminals 12 and 13 of the LCD substrate 2, because the ratio between the terminal width and the terminal pitch (a terminal width/terminal pitch ratio) of the COMMON terminals 12, 13, 22, and 23 (of the vicinity of the side portions) is smaller than that ratio of the terminals located in the middle portion. Thus, it is possible to further inhibit the imperfect connection.

By arranging the COMMON terminals and the SEGMENT terminals as described above, it is possible to absorb accumulated elongation, and misalignment.

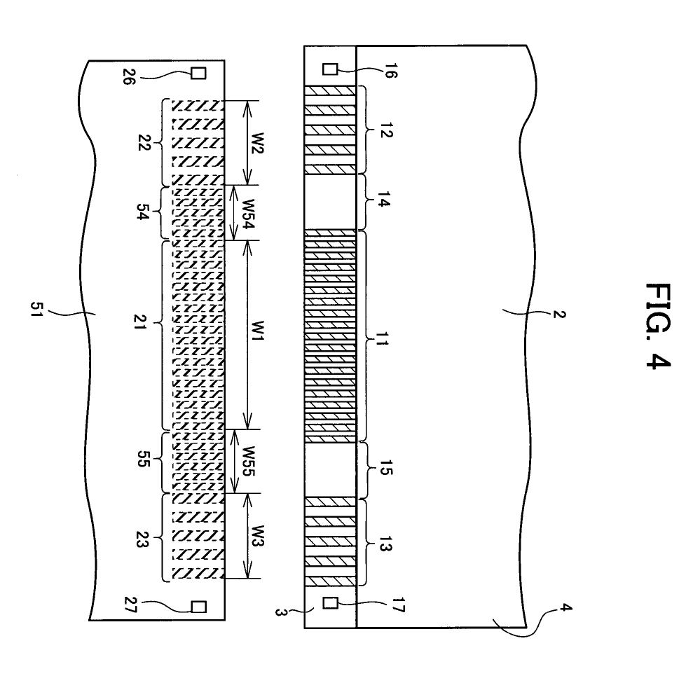

Described below is another embodiment of the present invention, referring to FIG. 4.

FIG. 4 is a plan view illustrating connecting portions of the flexible substrate 51 and of an LCD substrate 2 of another embodiment of the present invention, at which the flexible substrate 1 and the LCD substrate 2 are to be connected. The LCD substrate 2 has been described above. In the flexile substrate 51, sections similar and corresponding to the sections of the flexible substrate 1 are labeled in the same manner, and their explanation is omitted here. It should be noted that the flexible substrate 51 is provided with a plurality of dummy terminals 54 and 55 in non-formation areas 24 and 25, respectively.

The flexible substrate 51 may be so arranged that the dummy terminals 54 and 55 are formed with the same terminal pitch as the SEGMENT output terminals 21, but may be formed with the same terminal pitch as the COMMON terminals 22 and 23. Moreover, the flexible substrate 51 may be so arranged that the dummy terminals 54 and 55 are formed with an arbitrary terminal pitch. In this case, compensation rates (coefficient of thermal expansion) of each of the dummy terminals 54 and 55 should be worked out, from thermal compression bonding-caused changes in widths W54 and W55 of portions of the dummy terminals 54 and 55. On the other hand, if it is so arranged that the dummy terminals 54 and 55 have the same terminal pitch as the SEGMENT output terminals 21, or as the COMMON output terminals 22 and 23, it is possible to measure the widths W54 and W55 (in one batch) at the same time when the widths W1, W2, and W3 are measured. This attains more accurate measurement.

Moreover, the more electrode terminal portions, the smaller electrode-to-electrode areas in the non-formation areas 24 and 25. This makes it possible to reduce unevenness in a post-thermal-compression-bonding elongation amount (an amount of elongation caused after the thermal compression bonding) in the non-formation areas 24 and 25. As a result, in all terminal blocks, it is possible to connect the electrode terminals of the flexible substrate 51 with the electrode terminals of the LCD substrate 2 without misalignment. If it is so arranged that (a) the elongation of the flexible substrate is small, (b) unevenness in the coefficient of the thermal expansion is small, and (c) the greater terminal pitch the smaller terminal width/terminal pitch ratio, it is preferable that the terminal pitches of the dummy terminals 54 and 55 are the same as the SEGMENT output terminal 21 having the small terminal pitch.

By arranging such that the dummy electrodes 54 and 55 are provided in the non-formation areas 24 and 25 which essentially does not require electrode terminals therein, it is possible to reduce the amounts of the post-thermal-compression-bonding elongation and reduce the unevenness in the amount of the post-thermal-compression-bonding elongation. Therefore, it is possible to reduce an accumulated expansion amount that is accumulated in an area between the common output terminals 22 and 23 that are located outward with respect to the dummy electrodes 54 and 55. Further, it is possible to improve bonding strength.

It should be noted that the above explanation is based on the case where there are three terminal blocks, two of which have the same terminal pitches, and the rest of which has a different terminal pitch. However, the present invention is not limited to this. The present invention is also applicable in a case where each terminal block has a different pitch.

A flexible substrate of the present invention is, as described above, provided with a plurality of terminal blocks, each of which has a plurality of electrode terminals, there being two kinds of terminal pitches with which the plurality of electrode terminals are arrayed respectively in the plurality of terminal blocks, a post-thermal-compression-bonding elongation compensation amount (an amount of the compensation of the terminal pitch with respect to the elongation caused after the thermal compression bonding) being set for each terminal block in accordance with the terminal pitch thereof.

With this arrangement, the flexible substrate such as a TCP, a COF, an FPC and the like is connected with its counterparts (such as an LCD) with which the flexible substrate is to be connected. In connecting, the plurality of terminal blocks provided to the flexible substrate are connected with the corresponding terminal blocks of the counterparts, by the thermal compression bonding. As to the kind of the terminal pitches of the plurality of the terminal blocks, there are at least two kinds. That is, the plurality of the terminal blocks includes a first terminal block and a second terminal blocks having different terminal pitches. For example, in case where there are three terminal blocks, it may be so arranged that two of them have the same terminal pitch, whereas the rest has a different terminal pitch. Alternatively, it may be so arranged that the three terminal blocks have different terminal pitches.

Incidentally, it is necessary that the terminal pitches be set in consideration of the post-thermal-compression-bonding elongation compensation, because the flexible substrate and its counterparts with which the flexible substrate is to be connected have different coefficient of thermal expansion. Conventionally, in case where the terminal pitches are constant, elongation compensation in accordance with the coefficient of thermal expansion of the flexible substrate is carried out. However, in case of the flexible substrate in which at least one terminal block has a different terminal pitches of electrode terminals from that of the other terminal blocks, if the terminal pitches are small (less than 100 μm), the conventional elongation compensation cannot attain such good alignment between the flexible substrate and its counterpart (such as an LCD) that all of the terminal blocks are well connected with their counterpart terminal blocks respectively.

With this arrangement, it is possible to connect the electrode terminals of the flexible substrate with the electrode terminals of its counterpart (such as an LCD) with respect to all of the terminal block (that is, all of the terminal blocks are well connected with their counterpart terminal blocks respectively), because the compensation amounts are set in accordance with the terminal pitches (for each terminal pitches).

It is preferable that per terminal block, a line width and a space width (a space between lines (terminal electrodes)) of the terminal electrodes are so set as to absorb accumulated elongation and misalignment caused after the thermal compression bonding.

Furthermore, the present invention is preferably so arranged as to include a dummy terminal block respectively in non-formation areas in which the electrode terminals are not provided, the dummy terminal block having a plurality of dummy electrode terminals. Further, it is preferable that the dummy electrode terminals are identical with the electrode terminals of one of the terminal blocks. Moreover, it is preferable that the dummy electrode terminals have the same terminal pitch as the electrode terminals of one of the terminal blocks. Furthermore, it is preferable that the dummy electrode terminals have the same terminal pitch as the electrode terminals of at least one of the terminal blocks.

The formation area in which the electrode terminals are provided and the non-formation area in which no electrode terminal is provided, are made of different raw materials. Thus, the formation area and the non-formation area have different coefficients of thermal expansion. Because of this, the formation area and the non-formation are different in the unevenness in the post-thermal-compression-bonding elongation amount (the amount of elongation caused after the thermal compression bonding (in this case, the unevenness in the post-thermal-compression-bonding elongation amount in the non-formation area is greater than that unevenness in the formation area).

In view of this, in the above arrangement, the plurality of the dummy electrode terminals are formed in the non-formation area in which no electrode terminal is formed. With this arrangement, the electrode-to-electrode area in the non-formation area is reduced. Thus, it is possible to reduce the unevenness in the post-thermal-compression-bonding elongation amount in the non-formation area. As a result, for all the terminal blocks, it is possible to connect the electrode terminals of the flexible substrate and their counterpart electrode terminals (of the LCD and the like) with good alignment. In addition, it is possible to improve connection strength between the flexible substrate and the counterpart with which the flexible substrate is connected.

Moreover, it is preferable that the first terminal block has a terminal pitch smaller than a terminal pitch of the second terminal block; and a ratio of the line width over the terminal pitch, of the second terminal block is smaller than a ratio of the line width over the terminal pitch, of the first terminal block. Further, in this case, it is preferable that the flexible substrate includes a dummy terminal block in a non-formation area in which the electrode terminals are not provided, the dummy terminal block including a plurality of dummy electrode terminals having the same terminal pitch as the first terminal block (that has the smaller terminal pitch).

Moreover, a liquid crystal display module of the present invention is so arranged as to include any one of the flexible substrate described above.

With this arrangement, in an LCD module prepared by bonding a flexible substrate (such as a TCP, a COF, and an FPC) onto a substrate (such as glass) by using an anisotropic conductive material or the like, it is possible to attain good connection of the electrode terminals for all the terminal blocks without misalignment, by using the one of the flexible substrates described above. Specifically, when this arrangement is adopted in such an LCD and the one of the flexible substrates described above is used, for all the terminal blocks, the electrode terminals of the flexible substrate, and the electrode terminals of the counterpart with which the flexible substrate (such as an LCD) is connected, are connected without misalignment. In addition, it is possible to inhibit imperfect connection due to misalignment caused by the thermal compression bonding.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. A flexible substrate comprising:
a plurality of terminal blocks, each of which has a plurality of electrode terminals,
the plurality of terminal blocks including a first terminal block and a second terminal blocks having different terminal pitches,
a post-thermal-compression-bonding elongation compensation amount being set for each terminal block in accordance with the terminal pitch thereof.

2. The flexible substrate as set forth in claim 1, wherein:
per terminal block, a line width and a space width of the terminal electrodes are so set as to absorb accumulated elongation and misalignment caused after the thermal compression bonding.

3. The flexible substrate as set forth in claim 1, wherein:
the first terminal block has a terminal pitch smaller than a terminal pitch of the second terminal block;
a ratio of the line width over the terminal pitch, of the second terminal block is smaller than a ratio of the line width over the terminal pitch, of the first terminal block.

4. The flexible substrate as set forth in claim 1, comprising:
a dummy terminal block in non-formation areas in which the electrode terminals are not provided, the dummy terminal block having a plurality of dummy electrode terminals.

5. The flexible substrate as set forth in claim 4, wherein:
the dummy electrode terminals are identical with the electrode terminals of one of the terminal blocks.

6. The flexible substrate as set forth in claim 4, wherein:
the dummy electrode terminals have the same terminal pitch as the electrode terminals of one of the terminal blocks.

7. The flexible substrate as set forth in claim 3, comprising:
a dummy terminal block in a non-formation area in which the electrode terminals are not provided, the dummy terminal block including a plurality of dummy electrode terminals having the same terminal pitch as the first terminal block.

8. A liquid crystal display module comprising a flexible substrate, wherein:
the flexible substrate includes:
a plurality of terminal blocks, each of which has a plurality of electrode terminals,
the plurality of terminal blocks including a first terminal block and a second terminal blocks having different terminal pitches,
a post-thermal-compression-bonding elongation compensation amount being set for each terminal block in accordance with the terminal pitch thereof.

9. A method of manufacturing a liquid crystal display module in which a liquid crystal substrate is connected with a flexible substrate including a plurality of terminal blocks, each of the plurality of terminal blocks having a plurality of electrode terminals, and the plurality of terminal blocks including a first terminal block and a second terminal blocks having different terminal pitches, the method comprising the steps of:
performing compression bonding of a test flexible substrate made of the same material as the flexible substrate and including a plurality of terminal blocks having a predetermined terminal pitch;
measuring an amount of a size change in each terminal block, the size change caused by the compression bonding;
determining a compensation amount of the terminal pitch of each terminal block, based on the change amount in the size thereof;
setting terminal pitches of the flexible substrate by compensating the terminal pitches of the test flexible substrate by the compensation amount;
manufacturing the flexible substrate so that the flexible substrate has the thus set terminal pitches; and
performing thermal compressing bonding of the flexible substrate so as to connect the flexible substrate with the liquid crystal display apparatus,
wherein, in the step of determining, the compensation amount is determined for each terminal block having in accordance with the terminal pitch thereof.

10. The method as set forth in claim 9, wherein:
in the step of measuring, a change amount in a distance between outmost terminal electrodes, is measured, the outmost terminal electrodes located on both edges of each terminal block.
